(19) United States
(12) Patent Application Publication
(10) Pub. No.: US 2025/0063219 A1
(43) Pub. Date: Feb. 20, 2025

(54) PREFETCHING ADVERTISEMENTS FOR STREAMING DELIVERY

(71) Applicant: Sling TV L.L.C., Englewood, CO (US)

(72) Inventor: Chandra Nemalipuri, Englewood, CO (US)

(73) Assignee: Sling TV L.L.C., Englewood, CO (US)

(21) Appl. No.: 18/449,976

(22) Filed: Aug. 15, 2023

(51) Int. Cl. H04N 21/2668; H04N 21/231; H04N 21/239; H04N 21/438; H04N 21/44; H04N 21/81

(52) U.S. Cl. CPC H04N 21/2668; H04N 21/23106; H04N 21/2393; H04N 21/438; H04N 21/44016; H04N 21/812

(57) ABSTRACT

One example process includes receiving a master manifest for an advertisement, requesting a child manifest for the advertisement from the master manifest, and fetching a first ad segment identified in the child manifest. The master manifest identifies a plurality of child manifests for the advertisement. The child manifest corresponds to a selected bitrate. The method can also include fetching a second ad segment identified in the child manifest during playback of the first ad segment. The child manifest can include a uniform resource locator that resolves to a location of the first ad segment at an edge server. Other examples of related systems, processes, and devices are also disclosed herein.

### TECHNICAL FIELD

The following discussion generally relates to content delivery over broadcast and internet channels. Various embodiments prefetch advertisements for delivery to a particular user viewing a particular program.

### BACKGROUND

In the past, television viewing typically occurred at home, with one or more family members gathered in front of a television to watch a broadcast program. Television consumption has evolved from CRT screens coupled with an antenna to various viewing devices and delivery systems. Viewers can watch content using phones, tablets, personal computers, set-top boxes, televisions with integrated processing, or video game systems, for example. Additional functions and features have developed as television receivers, media players, and other media playback devices become increasingly sophisticated. Modern television receivers, for example, are capable of presenting additional data to accompany television broadcast content, or of taking any number of useful actions to enhance the viewer's enjoyment of their television programming.

While it would be desirable to allow the television receiver to take enhanced actions based upon the content of the advertisements or other portions of the live broadcast, this can prove difficult to implement in practice. In particular, it can be difficult for a cable provider, satellite broadcaster, or other content distributor to know in advance when certain targeted advertisements will match a suitable viewing slot. Moreover, it is not always possible to know in advance where the advertisements will be located or what advertisements will run due to the nature of live broadcasting. During a live broadcast of a sporting event, for example, the variable commercial break times and program length make it difficult to predict which content will air and when.

The various computing devices used to watch television today also have varied levels of computing power, with many being capable of delivering targeted advertisements. However, storing numerous copies of advertisements and waiting for a suitable viewing slot can waste storage and processing resources. Some delivery mechanisms are also subject to time constraints, which can make delivery of targeted advertisements difficult. During satellite broadcasts, for example, an available ad slot may not be identified until the segment of content with an available ad slot is being broadcast to a set-top box. Some satellite systems do not insert an ad in the first advertisement slot if there is not enough lead time.

It is therefore desirable to create systems, devices, and methods to reliably and quickly allow a content distributor to identify the specific advertisements and deliver advertisements in real time or near-real time. These and other desirable features and characteristics will become apparent from the subsequent detailed description and the appended claims, taken in conjunction with the accompanying drawings and this background section.

### SUMMARY

Systems, methods, and devices disclosed herein tend to conserve computing and communication resources during delivery of advertisements at variable bitrates. An example process for execution on a client device includes the steps of receiving a master manifest for an advertisement, requesting a child manifest for the advertisement from the master manifest, and fetching a first ad segment identified in the child manifest. The master manifest identifies a plurality of child manifests for the advertisement. The child manifest corresponds to a selected bitrate. The method can also include fetching a second ad segment identified in the child manifest during playback of the first ad segment.

In various embodiments, a bitrate is selected for playback based on available resources at the client device. A content stream is played at the client device at the selected bitrate. The client device fetches the first ad segment in response to an ad slot approaching in the content stream within a threshold period. The client device fetches a third ad segment identified in the child manifest during playback of the second ad segment. The client device can fetch the first ad segment from an origin and the second ad segment from an edge server. The child manifest can include a uniform resource locator that resolves to a location of the first ad segment at an edge server.

Another example process for execution at an edge server includes transmitting a master manifest for an advertisement. The master manifest identifies a plurality of child manifests for the advertisement. The edge server receives a request for a child manifest identified in the master manifest. The child manifest corresponds to a selected bitrate of the advertisement identified in the master manifest. The edge server checks a cache for ad segments identified in the child manifest at the selected bitrate. The ad segments identified in the child manifest are fetched in response to the ad segments being absent from the cache. The edger server transmits a first ad segment identified in the child manifest at the selected bitrate from the cache to the client device and transmits a second ad segment identified in the child manifest from the cache to the client device. The second ad segment is transmitted during playback of the first ad segment.

In some examples, the master manifest includes a plurality of uniform resource locators (URLs). A URL from the plurality of URLs corresponds to a child manifest identified in the master manifest. The child manifest can include a file identifier for each ad segment at the selected bitrate. The edge server can receive a request for the child manifest at the selected bitrate from a second client device, check the cache for the ad segments identified in the child manifest at the selected bitrate, and transmit the first ad segment from the cache to the second client device in response to detecting the first ad segment in the cache. The ad segments can be purged from the cache in response expiration of a retention period. The retention period can be reset in response to receiving a request for at least one of the master manifest, the child manifest, or the first ad segment. Other examples are contemplated by the present disclosure. Some such examples may be found in the figures, in the claims, or in the description of the present disclosure.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the illustrations.

FIG. 1 illustrates an example of a system for prefetching an advertisement for insertion in a content stream.

FIG. 2 illustrates an example of a process for fetching advertisements for playback in a content stream.

FIG. 3 illustrates an example of a process for serving advertisement segments for insertion into a content stream.

### DETAILED DESCRIPTION

The following detailed description is intended to provide several examples that will illustrate the broader concepts that are set forth herein, but it is not intended to limit the invention, application, or uses of the invention. Furthermore, there is no intention to be bound by any theory presented in the preceding background or the following detailed description.

Systems, methods, and devices disclosed herein can deliver advertisements quickly and efficiently in streamed content. Some examples use a content delivery network (CDN) to deliver advertisements dynamically and insert the advertisements in allocated advertisement slots in the content. The client device playing streamed content can send a request for the advertisement and its segments from the origin location when a new advertisement is introduced.

The client device, edge server, or CDN can check an advertisement cache for the ad at the requested bitrate. In response to cache-miss scenarios, a pre-fetch application can be invoked on the edge location. When a content player sends a request for the child manifest described below, the pre-fetch application may prefetch segments of that specific bitrate profile to the edge location serving the content to the client device. Advertisements can be fetched for a content stream at a bitrate selected for the streaming client device. The unselected or unused bitrates can be ignored by the edge server streaming to the client device. This tends to result in fewer copies of content at different bitrates being made and going unused.

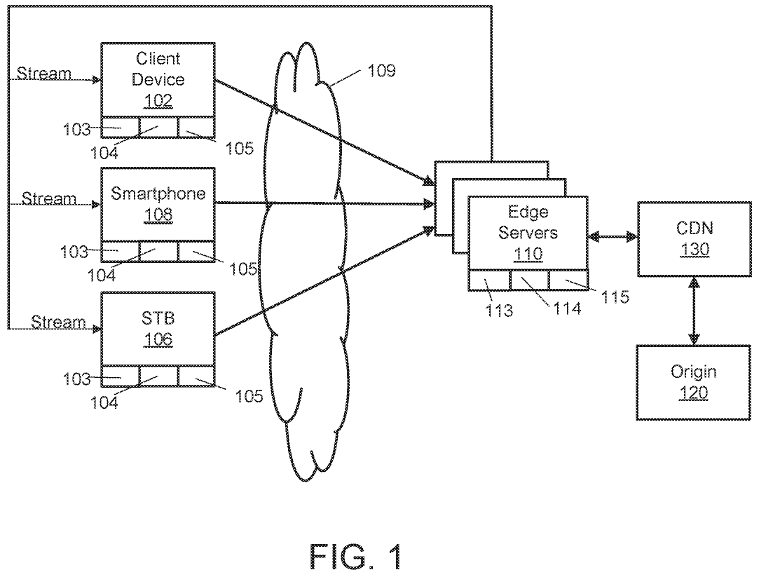

With reference to FIG. 1, an example system 100 is shown for delivering advertisements during streamed content according to various embodiments. System 100 includes a client device 102 in communication with an edge server 110 over network 109. Network 109 may include a wide area network (WAN) such as the Internet, a telephony network, a public or private network of any sort, a cellular network, or the like. Network 109 can be based upon TCP/IP protocols, or any other protocols as desired, including any protocols subsequently developed. Equivalent embodiments may integrate device location of client device 102 or streaming via local area networks.

Client device 102 can be any device capable of communicating on network 109 to stream content. Smartphone 108 and set-top box 106 (STB) are examples of client devices 102 depicted in FIG. 1. Other examples can include mobile phones, tablets, computers, televisions, smart speakers, receivers, soundbars, or similar devices communicating on network 109. Client device 102 includes hardware (e.g., processor 103, memory 104, input/output interfaces 105, permanent storage, bios, and the like). Client devices 102 typically run an operating system and applications capable of receiving a signal and outputting vidco.

In some implementations, client device 102 is a home-type server such as a local storage digital video recorder (LSDVR), placeshifting device, remote storage digital video recorder (RSDVR), or other media server device. One example of client device 102 suitable for use in some implementations could be the AirTV Classic device that is available from http://www.airtv.net, although equivalent embodiments could be used with any number of other DVRs, media receivers/players, video on demand (VOD) servers, set-top boxes, video game consoles, time or place shifting devices, computers, tablets, smartphones, or the like.

Client device 102 transmits data associated with a user account to edge server 110. Data can include advertisement data or adaptive bitrate requests. For example, client device 102 can receive a manifest file indicating upcoming ads are suitable for replacement and forward the request to an edge server along with a selection of a bitrate for the advertisement. Edge server 110 can be one or more network devices having conventional hardware such as a processor 113, memory 114, input/output interfaces 115 (e.g., a network interface), and an operating system running applications having various processing routes and modules. Edge server 110 can include a processor in communication with non-transitory data storage and an interface to network 109. The non-transitory data storage or memory can be configured to store computer-executable instructions that, when executed by the processor, cause edge server 110 to perform operations. Edge server 110 may be a standalone server, virtualized server, distributed computing cluster, container, networked computing device, or other computing resource capable of communicating with client device 102 over network 109. Multiple instances of edge server 110 may be spun up and running in virtualized or distributed environments in response to varied computing loads in different geographic regions. Edge servers 110 run multiple applications that are ancillary to content delivery, ad caching, and delivery as described herein.

Viewing data sent by client devices 102 to edge servers 110 can include the current program, stream, or channel being viewed. Viewing data can also include the current bitrate at which client devices 102 are streaming. Viewing data can be used to retrieve content or advertisements from origin 120, advertisement repository, demand-side platform, or other sources of advertisements or content. Client devices 102 receive media from CDN 130 or other media sources. For example, a suitable media source may be a local storage device formatted to include a database of media content, a file server, a cloud storage system, a television broadcaster, a video game device, a social media platform, an online video repository, a time or placeshifting device, or the like. In one example, CDN 130 can stream over the Internet to smartphone 108. CDN 130 in streaming examples can deliver content similar to the content commercially available under the SLING tradename.

Content source delivers ad-supported content that includes advertisement slots available for CDN 130 to fill. In some embodiments, CDN 130 receives advertisements from origin 120 and writes the advertisements into a content stream or to storage. Client devices 102 can also receive advertisements from edge server 110, CDN 130, or origin 120 to insert into a television broadcast or a content stream in a designated advertisement slot.

The media content delivered to client devices 102 is selectable by input on client device 102. Suitable content includes time or place shifted video, video on demand, over-the-air broadcasts, satellite broadcasts, video streams, or other media content for selection and display on client devices 102. Client devices 102 can also tune to broadcast channels to view scheduled programming in some embodiments.

Client devices 102 can transmit metadata to edge server 110 related to the content or advertisements consumed on client devices 102. Metadata can include a source channel, source IP address, source port, source name, timestamp, geolocation, internet service provider, device identifier, user account, program identifier, channel identifier, advertisement identifier, user demographics, or other metadata suitable for identifying the source, location, and time the content was replayed or recorded. Metadata can be used by edge server 110 or origin 120 to confirm the targeting requirements of an advertisement contracted by origin 120 were met during playback of the advertisement.

In some embodiments, edge server 110 is in communication with CDN 130 to prepare content including targeted advertisements for consumption by end users. CDN 130 can deliver content on the Internet or another network 109 as part of an RSDVR, VOD, or other media streaming service. A media player application executing on one or more client devices 102 may include logic to select content as needed to obtain and playback the media programs streams, broadcasts, or other media delivery channels. Content may be readily routable on network 109 and may be served by conventional CDN or other web-type servers, thereby providing a convenient mechanism for distributing media streams to a variety of different client devices 102 on network 109.

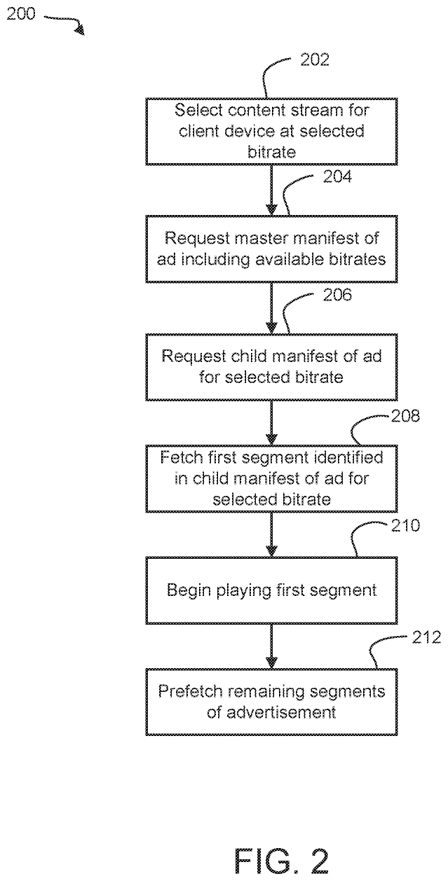

Referring now to FIG. 2, an example process 200 is shown for execution by a client device (e.g., client device 102, STB 106, smartphone 108, or other client device) streaming content, in accordance with various embodiments. Client devices 102 run an operating system and a playback application configured to communicate with edge server 110 to begin streaming content. Client device 102 selects a content stream at a selected bitrate (Block 202). The selected bitrate is also described herein as a bandwidth profile. The content stream can include linear content, over the top content, video on demand content, live content, or other audiovisual works suitable for streaming. An example of the content selectable for streaming by client device 102 can include, for example, content commercially available under the SLING tradename.

In various embodiments, the bitrate can be selected automatically by client device 102 using a bitrate algorithm. For example, the bitrate can start at a default bitrate and increase until a threshold value of packet loss, latency, bandwidth usage, or other capacity threshold is reached. In another example, client device 102 can start at a low bitrate and incrementally increase the bitrate until finding the highest resolution that results in a target framerate. The bitrate can be set manually by a user selecting a resolution in the player application running on client device 102. The bitrate can comprise a resolution, a frame rate, a codec, an audio component, a video range (i.e., SDR vs HRD), or other settings that affect the amount of data (e.g., bits per second) consumed to render the streamed content.

Client device 102 requests a master manifest for an advertisement (Block 204). The master manifest can be fetched in real-time in response to client device 102 detecting an approaching ad slot. Client device 102 fetches the master manifest by requesting the master manifest from edge server 110. Edge server 110 transmits the master manifest to client device 102 in response to the request.

In various embodiments, client device 102 may request the master manifest using a uniform resource locator (URL). The URL can encode metadata regarding client device 102, an authenticated user account, the streamed content, or other information usable by edge server 110 or origin 120 to select an ad manifest corresponding to a suitable ad for client device 102. In that regard, the URL can be a custom URL. The URL can also be a URL associated with the advertisement. The master manifest can include metadata identifying child manifests by their characteristics and an address corresponding to each child manifest. Different child manifests can be used to stream the advertisement at different bitrates based on the characteristics associated with the child manifests. The URL resolves to a location of the master manifest at edge server 110 or origin 120.

Client device 102 requests the child manifest of the advertisement corresponding to the selected bitrate (Block 206). Client device 102 reads the master manifest file to identify the child manifest associated with the selected bitrate or bandwidth profile of the content stream. The manifest file can be structured or can include delimiters, tags, or other indicia to read metadata associated with each child manifest file and select the desired child manifest address.

Client device 102 fetches the first segment of the advertisement (Block 208) from edge server 110 or origin 120. Client device 102 can request the identified child manifest file using an address in the master manifest associated with the child manifest file that has the desired bandwidth profile. The address for each child manifest file can be a URL that resolves to a location at edge server 110 or origin 120, for example. Edge servers 110 can host the segments for the selected bitrate or bandwidth in a local cache if the selected bitrate for the particular ad has been used by a client device 102 within the cache retention period. Ad segments can be purged from cache if no client device 102 requests a master manifest for the ad, a child manifest for the ad, or a segment of the ad, for example. The retention period can be reset in response to a request that resets the time-to-live associated with the cached asset. Edge servers 110 can retrieve segments for the advertisement at the selected bitrate from origin 120 in response to a cache miss (e.g., the selected bitrate of the advertisement is absent from the cache).

Client device 102 begins playing the first segment (Block 210) of the advertisement at the selected bitrate in real-time. In some examples, client device 102 can download and begin playing the first segment in response to an advertisement slot approaching or beginning. The advertisement slot can be identified as approaching in response to the ad slot appearing within a threshold period during playback of a content stream. For example, an ad slot that will appear within 5 seconds, 10 seconds, 20 seconds, 30 seconds, or any other duration of playback can be identified as approaching. Client device 102 can prefetch the remaining segments of the advertisement (Block 212). The remaining segments can be prefetched while the first segment is playing on client device 102. The majority of segments may be fetched when client device 102 is about to play the segments. For example, a 30 second advertisement can comprise 15 two-second segments. Client device 102 can fetch and begin playing the first segment and can prefetch the remaining 14 segments while the first segment is playing. Fetching the first segment and prefetching the remaining segments just-in-time for playback tends to conserve resources at client device 102, as well as bandwidth from edge servers 110 and origin 120.

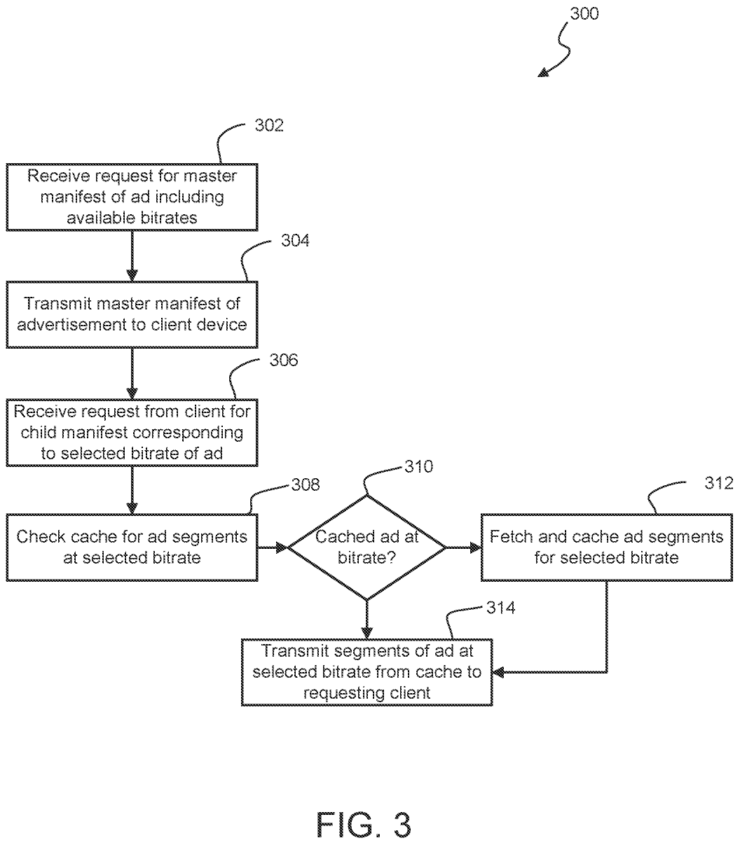

Referring now to FIG. 3, an example process 300 for execution by an edge server 110 or origin 120 is shown, according to various embodiments. Process 300 serves advertisement segments to client device 102 at the selected bitrate. Edge server 110 caches recently used advertisements at recently used bitrates. In response to cache misses, edge server 110 retrieves the segments for the advertisement at the desired bitrate, serves the segments to client device 102, and caches the segments for future distribution. In some examples, edge server 110 retrieves the entire advertisement from origin 120 and generates segments configured according to the desired bitrate or bandwidth profile. In some examples, origin 120 hosts the advertisement at various selectable bitrates and sends a requested bitrate to edge server 110 in response to a cache miss at edge server 110.

In various embodiments, edge server 110 receives a request for a master manifest file corresponding to an advertisement (Block 302). Once received, master manifest files are cached or stored by edge server 110. Master manifest files can be hosted at a URL for retrieval by client devices 102. In response to a particular master manifest being unavailable at the URL, edge server 110 can retrieve the master manifest from origin 120. Master manifest files can expire after being accessed by a client device 102 for a predetermined duration.

Some examples of edge server 110 include a web server configured to receive requests for access to URLs. Edge server 110 transmits the master manifest for an advertisement to client device 102 (Block 304). The master manifest can be transmitted in response to a request at a URL corresponding to the requested file. Each master manifest, child manifest, bitrate, or an advertisement can have a different URL. Edge server 110 caches master manifest, child manifest, or segments of an advertisement at selected bitrates for transmission to client devices 102 in response to requests at corresponding URLs.

Edge server 110 receives a request from client device 102 for a child manifest corresponding to a selected bandwidth profile from the master manifest (Block 306). The request for the child manifest can come in the form of a URL request to a web server hosted by edge server 110, for example. In response to receiving the request, edge server 110 attempts to retrieve the requested ad segment or ad segments.

Edge server 110 checks a cache for the requested segments of the advertisement at the selected bitrate (Block 308). The segments may each be identified in the child manifest. If edge server 110 does not have cached segments of the advertisement at the selected bitrate (Block 310), edge server 110 fetches and caches segments of the advertisement at the selected bitrate (Block 312). Edge server can retrieve the segments by requesting the segments from origin 120. Edge server 110 can fetch all segments for the advertisement at the selected bitrate in response to receiving the request at the child manifest URL, though segments can be sent to client device 102 in groups or individually.

If edge server 110 has the ad segments cached at the selected bitrate (Block 310), edge server 110 transmits segments of the ad from the cache to the requesting client device 102 (Block 314). Edge server 110 can transmit the first segment to client device 102 in response to a request from the client device. Each subsequent segment can be transmitted to the client device in response to a request for the segment, or a request for a group of segments. In one example, client device 102 requests each segment after the first segment during playback of the previous segment. Edge server 110 transmits the next segment to client device 102 during playback of the previous segment. In one example, client device 102 can have either zero or a single prefetched segment at any moment. Client device 102 retrieving only a single segment at a time tends to limit use of storage space for ad storage and tends to limit use of bandwidth. If client device 102 ceases playback, skips the ad, or changes the channel, for example, client device 102 does not use space or bandwidth on the un-fetched segments of the advertisement at the selected bitrate. Edge server 110 similarly preserves bandwidth by postponing transmission of individual ad segments until the segment is requested by client device 102 during playback of the previous segment.

In some examples, client device 102 requests the first segment of the advertisement at the selected bitrate, edge server 110 transmits the first segment, client device 102 requests the remaining segments during playback of the first segment, and edge server 110 transmits the remaining segments to client device 102 during playback of the first segment. The second segment can be prioritized so client device 102 receives the second segment before playback of the first segment completes.

Various embodiments tend to preserve bandwidth, storage space, and computing resources. Advertisement segments are cached at edge server 110 at a selected bitrate in response to a request from a client device. Edge server 110 may not retrieve and store unrequested bitrates of the advertisement. Edge server 110 can transmit segments of the advertisement at the selected bitrate just-in-time for playback, which tends to conserve computing and communication resources.

Systems, methods, and devices of the present disclosure tend to improve advertisement delivery. Advertisements are prefetched with enough lead time to replace a leading ad in linear programming. Satellite television providers, for example, can prefetch an advertisement and replace an advertisement within a few seconds of broadcast delay. Replaceable advertisements in live broadcasts can be identified and replaced by prefetching advertisements using techniques described above. Storage and computing resources can be conserved, and ad delivery metrics improved, by retaining prefetched advertisements for a viewing period or until the ad is viewed by a user fitting the ad criteria. Advertisements can also be prefetched just-in-time using the above techniques when advertisement slots are identifiable in advance.

Benefits, other advantages, and solutions to problems have been described herein with regard to specific embodiments. Furthermore, the connecting lines shown in the various figures contained herein are intended to represent examples of functional relationships or couplings between the various elements. It should be noted that many alternative or additional functional relationships or connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used herein, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

The term “exemplary” is used herein to represent one example, instance, or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. An automated process, comprising:
receiving, at a client device, a master manifest for an advertisement, wherein the master manifest identifies a plurality of child manifests for the advertisement;
requesting, by the client device, a child manifest for the advertisement from the master manifest, wherein the child manifest corresponds to a selected bitrate;
fetching, by the client device, a first ad segment identified in the child manifest; and
fetching, by the client device, a second ad segment identified in the child manifest during playback of the first ad segment.

2. The automated process of claim 1, further comprising selecting a bitrate for playback based on available resources.

3. The automated process of claim 2, further comprising playing a content stream at the selected bitrate.

4. The automated process of claim 3, wherein the client device fetches the first ad segment in response to an ad slot approaching in the content stream within a threshold period.

5. The automated process of claim 1, further comprising fetching, by the client device, a third ad segment identified in the child manifest during playback of the second ad segment.

6. The automated process of claim 1, wherein the client device fetches the first ad segment from an origin.

7. The automated process of claim 6, wherein the client device fetches the second ad segment from an edge server in communication with the origin.

8. The automated process of claim 1, wherein the child manifest comprises a uniform resource locator that resolves to a location of the first ad segment at an edge server.

9. An automated process, comprising:
transmitting, from an edge server and to a client device, a master manifest for an advertisement, wherein the master manifest identifies a plurality of child manifests for the advertisement;
receiving, by the edge server and from the client device, a request for a child manifest identified in the master manifest, wherein the child manifest corresponds to a selected bitrate of the advertisement identified in the master manifest;
checking, by the edge server, a cache for ad segments identified in the child manifest at the selected bitrate;
fetching, by the edge server and for storage in the cache, the ad segments identified in the child manifest in response to the ad segments being absent from the cache;
transmitting, by the edge server, a first ad segment identified in the child manifest at the selected bitrate from the cache to the client device; and
transmitting, by the edge server, a second ad segment identified in the child manifest from the cache to the client device, wherein the second ad segment is transmitted during playback of the first ad segment.

10. The automated process of claim 9, wherein the master manifest includes a plurality of uniform resource locators (URLs), wherein a URL from the plurality of URLs corresponds to a child manifest identified in the master manifest.

11. The automated process of claim 9, wherein the child manifest includes a file identifier for each ad segment at the selected bitrate.

12. The automated process of claim 9, further comprising:
receiving, by the edge server, a request for the child manifest at the selected bitrate from a second client device;
checking, by the edge server, the cache for the ad segments identified in the child manifest at the selected bitrate; and
transmitting, by the edge server, the first ad segment from the cache to the second client device in response to detecting the first ad segment in the cache.

13. The automated process of claim 9, further comprising purging the ad segments from the cache in response expiration of a retention period.

14. The automated process of claim 13, further comprising resetting the retention period in response to receiving a request for at least one of the master manifest, the child manifest, or the first ad segment.

15. A content delivery system comprising a processor in communication with a non-transitory storage medium configured to store instructions that, when executed by the processor, cause the content delivery system to perform operations, the operations comprising:
transmitting, from an edge server and to a client device, a master manifest for an advertisement, wherein the master manifest identifies a plurality of child manifests for the advertisement;
receiving, by the edge server and from the client device, a request for a child manifest identified in the master manifest, wherein the child manifest corresponds to a selected bitrate of the advertisement identified in the master manifest;
checking, by the edge server, a cache for ad segments identified in the child manifest at the selected bitrate;
fetching, by the edge server and for storage in the cache, the ad segments identified in the child manifest in response to the ad segments being absent from the cache;
transmitting, by the edge server, a first ad segment identified in the child manifest at the selected bitrate from the cache to the client device; and
transmitting, by the edge server, a second ad segment identified in the child manifest from the cache to the client device, wherein the second ad segment is transmitted during playback of the first ad segment.

16. The content delivery system of claim 15, wherein the master manifest includes a plurality of uniform resource locators (URLs), wherein a URL from the plurality of URLs corresponds to a child manifest identified in the master manifest.

17. The content delivery system of claim 15, wherein the child manifest includes a file identifier for each ad segment at the selected bitrate.

18. The content delivery system of claim 15, wherein the operations further comprise:
receiving, by the edge server, a request for the child manifest at the selected bitrate from a second client device;
checking, by the edge server, the cache for the ad segments identified in the child manifest at the selected bitrate; and
transmitting, by the edge server, the first ad segment from the cache to the second client device in response to detecting the first ad segment in the cache.

19. The content delivery system of claim 15, wherein the operations further comprise purging the ad segments from the cache in response expiration of a retention period.

20. The content delivery system of claim 19, wherein the operations further comprise resetting the retention period in response to receiving a request for at least one of the master manifest, the child manifest, or the first ad segment.
